(19) United States
(12) Patent Application Publication
(10) Pub. No.: US 2009/0200824 A1
(43) Pub. Date: Aug. 13, 2009

(54) SLIDEOUT ROOM JACK SCREW ADJUSTOR

(75) Inventor: Bernard F. Garceau, Vandalia, MI (US)

Correspondence Address: HAHN LOESER & PARKS, LLP, One GOJO Plaza, Suite 300, AKRON, OH, 44311-1076, US

(73) Assignee: NORCO INDUSTRIES, INC., Compton, CA (US)

(21) Appl. No.: 12/028,333

(22) Filed: Feb. 8, 2008

(51) Int. Cl. B60P 3/34

(52) U.S. Cl. 296/26.13; 254/98

(57) ABSTRACT

The present disclosure relates to a support system having a slideout room, a trailer frame assembly and a jack screw assembly to increase, decrease or level the vertical placement of the slideout room. The frame assembly has extendable support members connected to a plurality of jack screw assemblies with telescopic tubes to extend, decrease or level the vertical placement of the slideout room. The telescopic tubes have a mounting plate on one end that attaches to the slideout room and a mounting bracket on the other end that attaches to the extendable support members.

### FIELD OF THE INVENTION

The invention relates generally to a support system for trailers and motor vehicles, including without limitation recreational vehicles (RV's), utility trailers, and the like (hereinafter collectively “trailers”). More specifically, the present invention relates to a support system having a trailer frame, a slideout room and a jack screw assembly for increasing, decreasing, or leveling the height of a slideout room.

### BACKGROUND OF THE INVENTION

Recreational vehicles may be used for vacationing and traveling as a substitute for living quarters. Recreation vehicles including motor homes, fifth wheel trailers and travel trailers may be provided with an extendable slideout unit for increasing the vehicle's living space. This slideout unit may be extended for use when the vehicle is parked and is retracted in a telescoping manner when the vehicle is to be moved. Generally, a recreational vehicle has a frame assembly that supports the living quarters. The living quarter frame may have an adjustable room bracket to raise or lower the slideout room. Most adjustable room brackets require jacks or some separate supports to hold the body of the slideout room assembly while the bracket is being adjusted.

### SUMMARY OF THE INVENTION

The present support system for a slideout room has a jack screw assembly that increases, decreases or levels a slide out room while remaining attached to the slide out room and trailer frame assembly. The present device fully supports the end of a slideout room while the adjustments are being made and uses telescoping tubes to increase, decrease or level the placement of a slideout room. In the presently described embodiment, the telescoping tubes form a compact jack screw assembly.

The present disclosure relates to a support system comprising a slideout room, a frame assembly having extendable support members, and a jack screw assembly attached to each of the extendable support members and the slideout room, wherein the jack screw assembly has an exterior tube with a top end and a bottom end and an interior tube with a top end and a bottom end, wherein the interior tube and exterior tube telescopically extend. The support system has a drive mechanism with a drive rod that extends the interior tube and exterior tube to adjust the vertical placement or level the placement of the slideout room.

The present disclosure also relates to a combination of a slideout room, a frame assembly having a plurality of extendable slideout room support members, and a jack screw assembly attached to an exterior end of each extendable slideout room support member for adjusting the vertical placement of the slideout room. The jack screw assembly has an exterior tube with a top end and a bottom end and an interior tube with a top end and a bottom end, wherein the exterior tube and the interior tube telescopically extend along the vertical axis.

The present disclosure further relates to a combination of a vehicle frame, the vehicle frame including a plurality of slidable room support members movable between a retracted position and an extended position, the slidable room support members extending along the horizontal axis beyond a periphery of the vehicle frame when in the extended position; and a slidable room supported on the vehicle frame and the plurality of slidable room support members; and a plurality of jack screws, one jack screw being attached to an end of each slidable room support member and being attached to the slidable room, wherein the jack screws extend along a vertical axis.

The foregoing and other aspects will become apparent from the following detailed description of the invention when considered in conjunction with the accompanying drawing figures.

### BRIEF DESCRIPTION OF THE DRAWINGS

FIG. 1 is a perspective view of the slideout room in a retracted position.

FIG. 2 is a perspective view of the slideout room as shown in FIG. 1 in an extended position.

FIG. 3 is a perspective view of the extendable support members, trailer frame assembly and the jack screw assembly.

FIG. 4 is a perspective view of the jack screw assembly shown in FIG. 3.

FIG. 5 is a cross-sectional view of the exterior tube and interior tube of the jack screw assembly of FIG. 4.

FIG. 6 is a perspective view of the interior tube of the jack screw assembly of FIG. 4.

FIG. 7 is a perspective view of the exterior tube of the jack screw assembly of FIG. 4.

### DETAILED DESCRIPTION OF THE DRAWINGS

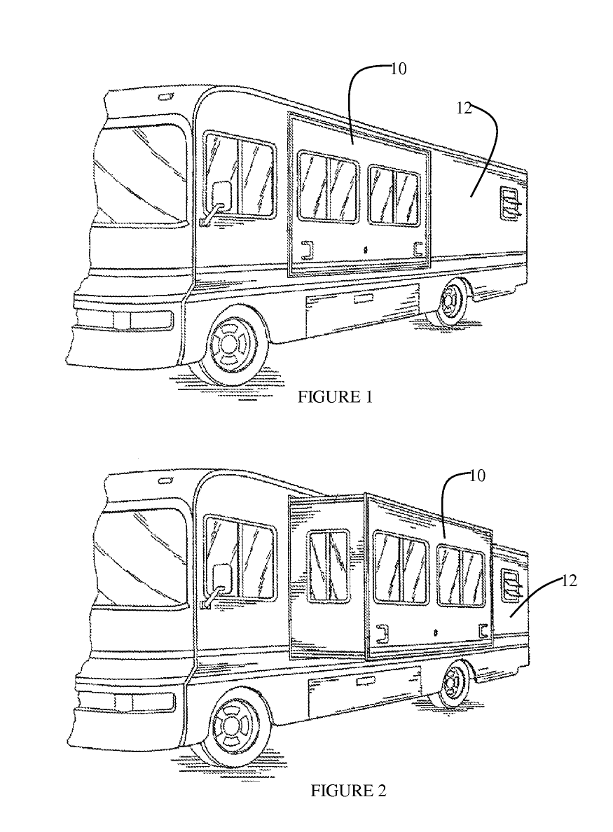

Referring now to the drawings wherein the showings are for purposes of illustrating embodiments of the invention only and not for purposes of limiting the same, FIG. 1 and FIG. 2, show a slideout room 10 that is part of the body of a trailer frame 16. The term trailer frame 16 refers to trailer frames used with recreational vehicles (RV's), utility trailers, and the like.

Referring now to FIGS. 1 through 2, the slideout room 10 is connected to a vehicle comprising a vehicle body 12 having one or more room slideout units that are horizontally reciprocable relative to the vehicle body 12 between a retracted position shown in FIG. 1 and an extended (or second) position shown in FIG. 2. The vehicle can be a motor home, a fifth wheel trailer or a travel trailer. The slideout room 10, when extended, affords more room or space to the interior of the vehicle.

The vehicle may be a self-powered vehicle, such as a recreational vehicle, or may be a trailer that is adapted to be towed, e.g., by an automobile or a truck tractor. The vehicle may be one that is designed for living (as a house trailer), or may be a work vehicle (e.g., a mobile library).

The slideout unit 10 should always be retracted, as shown in FIG. 1, when the vehicle is in motion. When the vehicle is parked or stationary, the slideout room 10 may be slid to the extended position shown in FIG. 2, to afford additional room in the interior of the vehicle. The slideout room 10 can extend sideways, to the front, to the back, or in any other direction relative to the trailer frame 16.

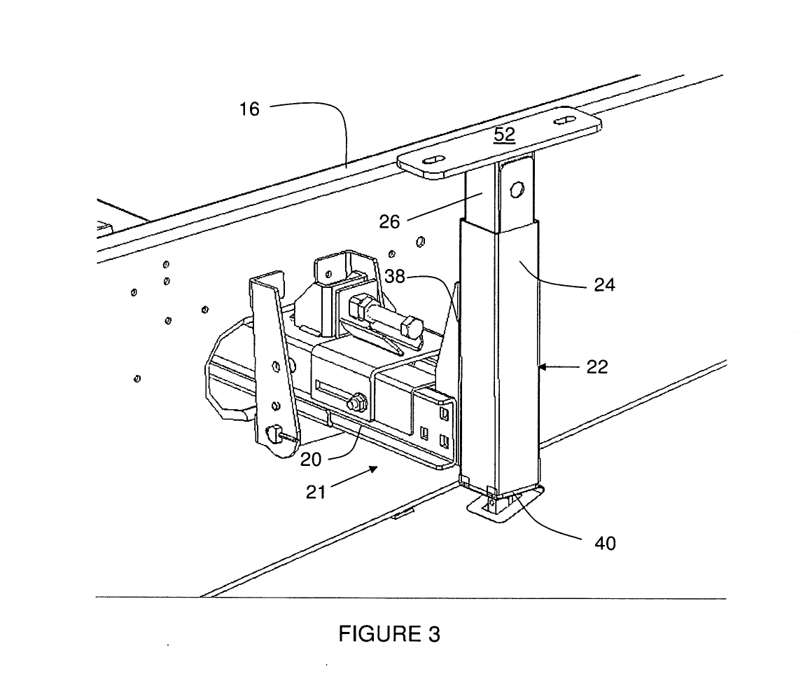

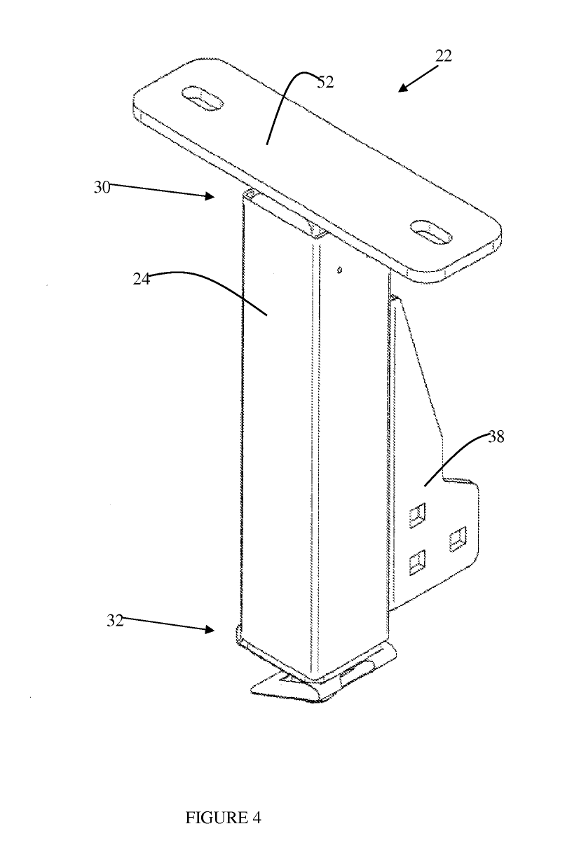

Referring to FIGS. 3 and 4, the jack screw assembly 22 is used in combination with a trailer frame assembly 16 and slideout room 10 of a recreational vehicle or utility trailer. The trailer frame assembly 16 may be constructed from any known means in the art. The trailer frame assembly 16 has a plurality of slidable room support members 20 that have an interior end (not shown) and an exterior end 21. The slidable room support members 20 extend in the horizontal direction beyond the periphery of the trailer frame assembly 16 when in an extended position. A jack screw assembly 22 is bolted, riveted, screwed, or otherwise connected to the exterior end 21 of the slidable support members 20 (fasteners not shown).

A jack screw is typically defined, but without limitation, as a device that lifts heavy objects short heights, using various mechanical, pneumatic or hydraulic methods. In the presently contemplated embodiment, the type of jack screw is an acme screw. The acme screw has a screw/nut drive mechanism 28 that may utilize a threaded screw and nut.

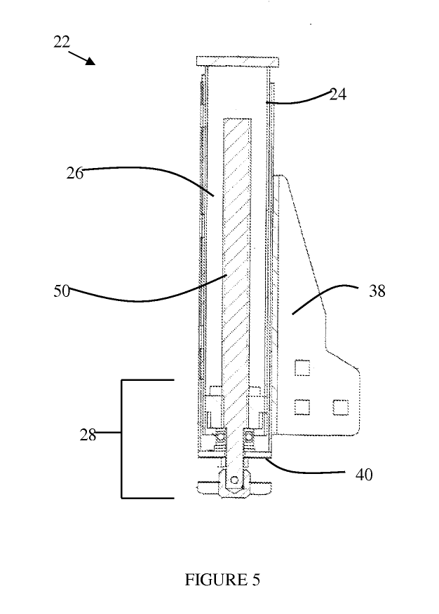

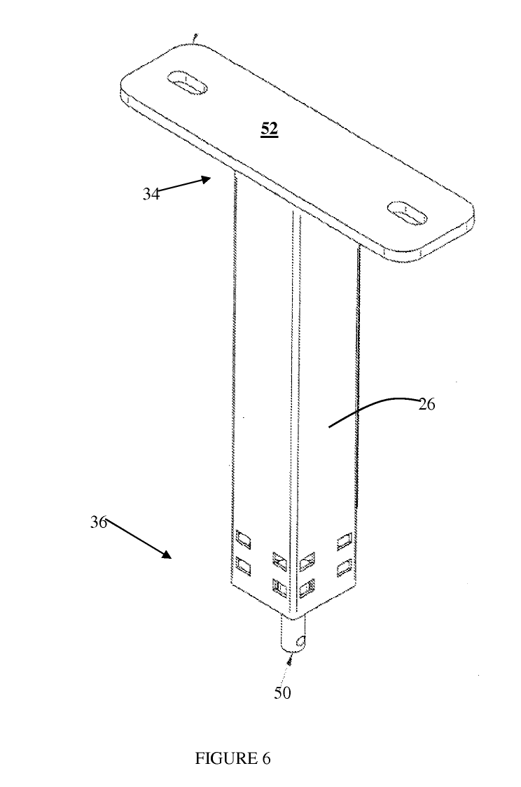

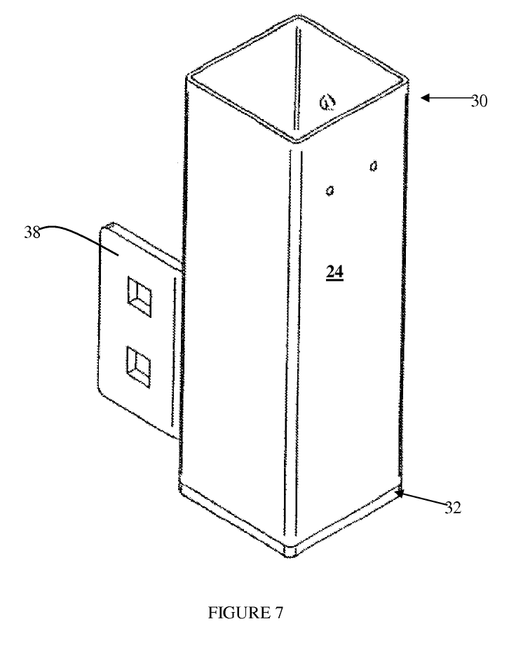

In one embodiment, the jack screw assembly 22 comprises an exterior tube 24, an interior tube 26, and a drive mechanism 28. The interior tube 26 and exterior tube 24 may have a rectangular shape as shown in the present embodiment. However, the interior tube 26 and exterior tube 24 are not limited to this particular embodiment and may take a rounded or other polygonal shape. The jack screw assembly 22 may be constructed from any rigid material that can withstand a large amount of force being applied upon it. The materials can include, but are not limited to metals or plastics or a combination of both. Referring to FIG. 5, the exterior tube 24 and interior tube 26 of the jack screw assembly 22 can telescopically extend along a vertical axis to adjust the height of a slideout room 10.

The exterior tube 24 of the jack screw assembly 22 attaches to the slidable room support members 20. The exterior tube 24 has a top end 30 and a bottom end 32. The exterior tube 24 may remain stationary while the height of the slideout room 10 is adjusted. It is noted that any outside portion of the jack screw assembly 22 may remain stationary during adjustment of the slideout room 10.

In the present embodiment, the exterior tube 24 is attached to the trailer frame assembly 16 by way of a mounting bracket 38. One end of the mounting bracket 38 is attached to one of the exterior tube 24 and interior tube 26. At the opposite end, the mounting bracket 38 has slots or openings to connect the jack screw assembly 22 to the support members 20. The present support system is not limited to any particular configuration, and either the interior tube 26 and exterior tube 24 can be attached to the support members 20. The mounting bracket 38 may be bolted, screwed, riveted or otherwise connected to the support members 20 through fasteners (not shown) such as bolts, screws, or nails.

The jack screw assembly 22 has an interior tube 26 located within the exterior tube 24 that telescopically extends in a vertical direction. The interior tube 26 has a top end 34 and a bottom end 36. The interior tube 26 has a shape corresponding to the exterior tube 24 with a bottom end 36 disposed inside the exterior tube 24 and a top end 34 extending beyond the exterior tube 24 top end 30. The exterior dimensions of the interior tube 26 are proportioned so as to form a sliding fit within the inside dimensions of the exterior tube 24. The interior tube 26 and the exterior tube 24 are telescopically driven into the extended position by a drive mechanism 28. The top end 34 of the interior tube 26 or top end 30 of the exterior tube 24 has a mounting plate 52 that attaches to at least one side of the slideout room 10. The mounting plate 52 is bolted, riveted, screwed, or otherwise fastened (fasteners not shown) to one side of the slideout room 10.

In the present embodiment as shown in FIGS. 3 and 4, the bottom end 36 of the exterior tube 24 has an end plate 40. The end plate 40 prevents the interior tube 26 from extending below the bottom end 32 of the exterior tube 24 and allows the drive rod 50 to extend through the bottom end 32 of the exterior tube 24 and the bottom end 36 of interior tube 26. In this embodiment, the interior tube 26 and exterior tube 24 may provide a compact system that may require less space during operation of the jack screw assembly 22. The present embodiment is not limited to any particular arrangement of the interior and exterior tubes. It is noted that the bottom end 36 of the interior tube 26 may have an end plate 40 to prevent the exterior tube 24 from extending below the bottom end 36 of the interior tube 26.

In the present embodiment, the drive mechanism 28 is a screw and nut drive system comprising a threaded drive rod 50, nylon spacer, bearing washer, bearing thrust ball, hex drive adapter, and hex drive adapter spring clip. The drive rod 50 extends from the bottom end 36 of the interior tube 26 to the top end 34 of the interior tube 26. The hex drive adapter and hex adapter spring clip may be located at the bottom end 36 of the interior tube 26 and exterior tube 24.

In operation, lifting is achieved by turning the drive rod 50 with a wrench. In a first or active position, the drive rod 50 extends the interior tube 26 through the top end 30 of the exterior tube 24 in the vertical direction. In a second or deactivated position, the drive rod 50 is turned in the opposite direction and the interior tube 26 returns to the initial position by a vertical downward movement through the top end 30 of the exterior tube 24. The interior tube 26 continues to move downward until the interior tube 26 forms a sliding fit within the inside dimensions of the exterior tube 24 and the mounting plate 52 rests on the top end 30 of the exterior tube 24. The interior tube 26 and the exterior tube 24 of the jack screw assembly 22 extend along the vertical axis to adjust the height or level the placement of the slideout room 10 while the slidable room support members 20 extend along the horizontal axis to extend and retract the slideout room 10.

The foregoing is an illustration of the invention, which is described with respect to specified embodiments, and is not intended as a limitation. Consequently, other modifications or variations to the specific apparatuses and methods described will be apparent to those skilled in the art and will fall within the spirit of the invention and the scope of the following claims.

What is claimed is:

1. A support system comprising:
a slideout room,
a frame assembly having extendable support members, and
a jack screw assembly attached to each of the extendable support members and the slideout room, wherein the jack screw assembly has an exterior tube with a top end and a bottom end and an interior tube with a top end and a bottom end;
wherein the interior tube and the exterior tube telescopically extend.

2. The support system of claim 1, further comprising a drive mechanism having a drive rod therein, the drive rod extending one of the interior tube and the exterior tube, wherein the interior and the exterior tubes adjust the vertical placement of the slideout room.

3. The support system of claim 1, wherein the bottom end of one of the exterior tube and the interior tube has an end plate to prevent the other of the interior tube and the exterior tube from extending below the bottom end of said one of the exterior tube and the interior tube.

4. The support system of claim 1, further comprising a mounting plate on the top end of one of the interior tube and the exterior tube for supporting the slideout room.

5. The support system of claim 1, wherein each jack screw assembly includes at least one mounting bracket attaching the jack screw assembly to the extendable support members.

6. In combination a slideout room, a frame assembly having a plurality of extendable slideout room support members, and a jack screw assembly attached to the slideout room and an exterior end of each extendable slideout room support members for adjusting the vertical placement of the slideout room, wherein the jack screw assembly has an exterior tube with a top end and a bottom end and an interior tube with a top end and a bottom end, wherein the exterior tube and the interior tube telescopically extend along the vertical axis.

7. The combination of claim 6, further comprising a drive mechanism having a top end, a bottom end, and a drive rod therein, the drive rod extending one of the exterior tube and the interior tube to adjust the vertical placement of the slideout room.

8. In combination:
a vehicle frame, the vehicle frame including a plurality of slidable room support members movable between a retracted position and an extended position, the slidable room support members extending along the horizontal axis beyond a periphery of the vehicle frame when in the extended position; and
a slidable room supported on the vehicle frame and the plurality of slidable room support members; and
a plurality of jack screws, one jack screw being attached to an end of each slidable room support member and being attached to the slidable room, wherein the jack screws extend along a vertical axis.
